(19) United States
(12) Patent Application Publication
(10) Pub. No.: US 2024/0193712 A1
(43) Pub. Date: Jun. 13, 2024

(54) TOKEN MANAGEMENT PROGRAM, TOKEN MANAGEMENT SYSTEM, AND TOKEN MANAGEMENT METHOD

(71) Applicants: Square Enix Co. Ltd., Tokyo (JP); double jump.tokyo Inc., Tokyo (JP)

(72) Inventors: Keisuke HATA, Tokyo (JP); Atsushi YOSHIMEKI, Tokyo (JP); Takahide NOJIMA, Tokyo (JP); Yu WATANABE, Tokyo (JP); Yasuaki SAKAMOTO, Tokyo (JP); Masaaki KATO, Kyoto (JP)

(21) Appl. No.: 18/534,389

(22) Filed: Dec. 8, 2023

(30) Foreign Application Priority Data
Dec. 8, 2022 (JP) 2022-196191

(51) Int. Cl. G06Q 50/18

(52) U.S. Cl. CPC G06Q 50/184

(57) ABSTRACT

Non-transitory computer-readable media, systems, and methods are disclosed for a token management. An example non-transitory computer-readable medium stores a token management program including instructions, when executed by one or more processors, causes a computer to perform instructions including: combining a first object corresponding to a first token and a second object corresponding to a second token through superimposition; and generating a third token according to the combination.

### CROSS-REFERENCE TO RELATED APPLICATION(S)

The present disclosure claims priority to Japanese Patent Application No. 2022-196191, filed on Dec. 8, 2022, the disclosure of which is expressly incorporated herein by reference in its entirety for any purpose.

### TECHNICAL FIELD

At least one embodiment of the present disclosure relates to a token management program, a token management system, and a token management method.

### BACKGROUND

Technologies using various tokens such as non-fungible tokens (NFTs) using blockchains have emerged.

Examples of a game system capable of transmitting and receiving in-game non-fungible assets in a game played by a user as NFTs between in-game and out-of-game may be found in JP2021-152815A. The game system includes a game management unit that manages a game, an asset management unit that manages in-game non-fungible assets, and an administrator-side wallet unit that designates mutual addresses between a user wallet units of a user and the administrator-side wallet unit to transmit and receive NFTs by storing NFTs on blockchains via a network. When in-game non-fungible assets are transmitted to outside of the game, the asset management unit deletes owner information regarding the in-game non-fungible assets, and the administrator-side wallet unit issues an in-game non-fungible asset as an NFT, and transmits the NFT to the wallet address designated by the user.

Tokens may be associated with objects. Examples of the objects include content such as image data, video data, and sound data.

Here, when a plurality of tokens and a plurality of corresponding objects are combined and the objects are superimposed, for example, playful minds by affixing a sticker from the upper side can be expressed, and thus interests of users can be enhanced.

### SUMMARY

An object of at least one embodiment of the present disclosure is to solve the foregoing problem and increase an interest of a user.

From a non-limiting point of view, a token management program according to an embodiment of the present disclosure causes a computer to implement a combination function of combining a first object corresponding to a first token and a second object corresponding to a second token through superimposition, and a token generation function of generating a third token according to the combination.

From a non-limiting point of view, a token management system according to an embodiment of the present disclosure includes a communication network, a server, and a user terminal, the system including a combination means configured to combine a first object corresponding to a first token and a second object corresponding to a second token through superimposition, and a token generation means configured to generate a third token according to the combination.

From a non-limiting point of view, a token management method by a computer according to an embodiment of the present disclosure is a method including a combination process of combining a first object corresponding to a first token and a second object corresponding to a second token through superimposition, and a token generation process of generating a third token according to the combination.

Embodiments of the present application address one or more deficiencies.

### BRIEF DESCRIPTION OF THE DRAWINGS

FIG. 1 is a block diagram illustrating an example of a configuration of a token management system according to at least one embodiment of the present disclosure;

FIG. 2 is a block diagram illustrating a configuration of a server according to at least one embodiment of the present disclosure;

FIG. 3 is a flowchart illustrating a processing example of a token management program according to at least one embodiment of the present disclosure;

FIG. 4 is a conceptual diagram illustrating an example of superimposition of two objects according to at least one embodiment of the present disclosure; and

FIG. 5 is a conceptual diagram illustrating an example of superimposition of three or more objects according to at least one embodiment of the present disclosure.

### DETAILED DESCRIPTION

Hereinafter, embodiments of the present disclosure will be described with reference to the drawings. Various constituent elements in the following embodiments can be appropriately combined within a range in which contradiction or the like does not occur. With respect to the content described as an example of a certain embodiment, description thereof may be omitted in other embodiments. Content of operations and processes that are not related to the features of each embodiment may be omitted. Orders of various processes configuring various flows and sequences to be described below are random as long as there is no contradiction in the processing contents.

Hereinafter, a token management program executed in a server which is an example of a computer will be described as an example. Here, the computer may be another device such as a user terminal.

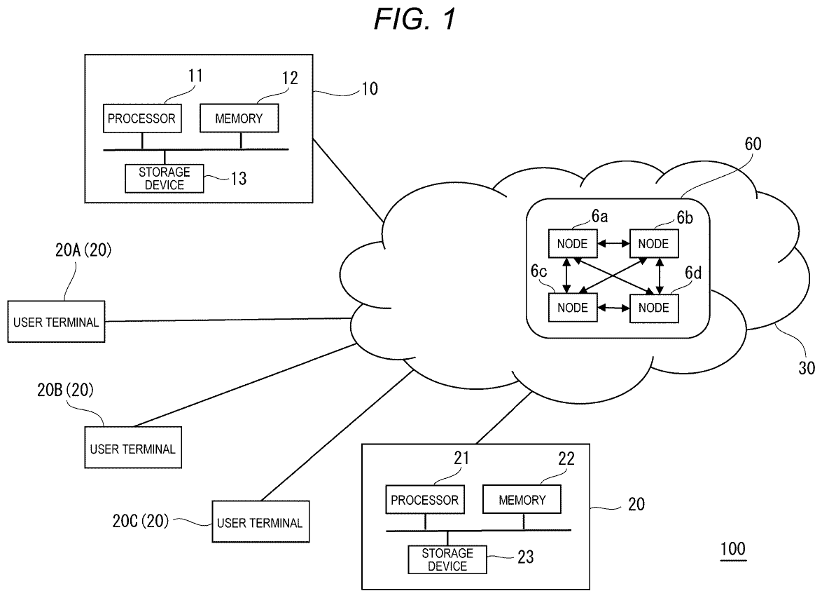

FIG. 1 is a block diagram illustrating an example of a configuration of a token management system 100 according to at least one embodiment of the present disclosure. The token management system 100 includes a server 10 and user terminals 20 used by users of the token management system 100. Each of user terminals 20A, 20B, and 20C is an example of the user terminal 20. The configuration of the token management system 100 is not limited thereto. For example, the token management system 100 may be configured such that a single user terminal is used by a plurality of users. The token management system 100 may include a plurality of servers.

Each of the server 10 and the user terminal 20 is an example of a computer. Each of the server 10 and the user terminal 20 is connected to be able to communicate with a communication network 30 such as the Internet. Connection between the communication network 30 and the server 10 and connection between the communication network 30 and the user terminal 20 may be wired or wireless. For example, the user terminal 20 may be connected to the communication network 30 by executing data communication with a base station managed by a communication service provider via a wireless communication line.

The token management system 100 includes the server 10 and the user terminal 20 to implement various functions for executing various processes in response to operations of the users.

The server 10 may be a game processing server that controls progress of a game. Here, the server 10 controls the progress of the game in response to an operation of a player. The server 10 may provide various electronic services not limited to a game to the users.

The server 10 includes a processor 11, a memory 12, and a storage device 13. The processor 11 is, for example, a central processing unit (CPU) that executes various types of calculation and control. When the server 10 includes a graphics processing unit (GPU), the GPU may execute some of the various types of calculation and control. The server 10 uses data read to the memory 12 to cause the processor 11 to execute various types of information processing, and the storage device 13 to store the obtained processing results as necessary.

The storage device 13 has a function as a storage medium that stores various types of information. The configuration of the storage device 13 is not particularly limited, but from the viewpoint of reducing a processing load on the user terminal 20, all the various types of information necessary for the control executed by the token management system 100 may be storable. Such examples include HDDs and SSDs. However, the storage device storing various types of information only needs to include a storage area that can be accessed by the server 10, and may be configured to have a dedicated storage area outside of the server 10, for example.

The server 10 may be configured with an information processing device such as a game processing server capable of rendering game images.

The user terminal 20 is managed by the user. Examples of the user terminal 20 include mobile phone terminals, smartphones, personal digital assistants (PDAs), personal computers, tablets, stationary game devices, and portable game devices. The user terminal 20 may be any of virtual reality (VR) goggles, augmented reality (AR) glasses, smart glasses, AR contacts, or other wearable devices which can be operated by a user.

The user terminal may be a communication terminal capable of playing a network distribution type game.

The user terminal 20 is connected to the communication network 30, and includes hardware and software executing various processes by communicating with the server 10. The plurality of user terminals 20 may be configured to be able to directly communicate with each other without involving the server 10.

The user terminal 20 may have a built-in display device. A display device may be wirelessly connected or wired to the user terminal 20. The display device has a very general configuration, and thus illustration is omitted here. The display device is an example of an output device. When the user plays a game using the user terminal 20, a game screen is displayed as a synthesized image on the display device, so that the user recognizes the synthesized image. When the user executes various types of information processing using the user terminal 20, a screen necessary for information processing (information processing screen) is displayed as an image by the display device, so that the user recognizes the image. The game screen and the information processing screen are displayed, for example, on a display which is an example of a display device included in the user terminal or a display which is an example of a display device connected to the user terminal. Examples of the display device include a hologram display device capable of displaying a hologram, a projection device projecting an image (including a game screen and an information processing screen) on a screen or the like, and an XR display device. XR includes VR, AR, mixed reality (MR), and substitutional reality (SR).

The user terminal 20 includes a processor 21, a memory 22, and a storage device 23. The processor 21 is, for example, a CPU that executes various types of calculation and control. When the user terminal 20 includes a GPU, the GPU may execute some of the various types of calculation and control. The user terminal 20 uses data read to the memory 22 to cause the processor 21 to execute various types of information processing, and the storage device 23 to store the obtained processing results as necessary. The storage device 23 has a function as a storage medium that stores various types of information.

The user terminal 20 may have a built-in input device. An input device may be wirelessly connected or wired to the user terminal 20. The input device receives an operation input by a user. A processor included in the server 10 or a processor included in the user terminal 20 executes various control processes in response to an operation input by the user. Examples of input devices include touch panel screens of smartphones, tablets, or the like, keyboards, mouses, game pads, joysticks, and other controllers. A camera built in or connected to the user terminal 20 may also correspond to the input device. The user executes an operation input by a gesture such as a motion of a hand in front of the camera (gesture input).

The user terminal 20 may include other output devices such as speakers. Other output devices output sounds, vibrations, and various other types of information to the user.

The communication network 30 includes a blockchain network 60. The blockchain network 60 is constructed by a plurality of nodes such as computers. As examples of the plurality of nodes, nodes 6a, 6b, 6c, and 6d which are each a computer, are illustrated in FIG. 1. The drawing is merely exemplary, and the number of nodes may not be four. The blockchain network 60 may be constructed as a network separate from the illustrated communication network 30.

The plurality of nodes 6a to 6d are typically interconnected in a peer-to-peer manner to form the blockchain network 60. A distributed ledger is stored in the storage device of each node. The server 10 or the user terminal 20 may be connected to be able to communicate with the blockchain network 60. The server 10 or the user terminal 20 may function as a node included in the blockchain network 60.

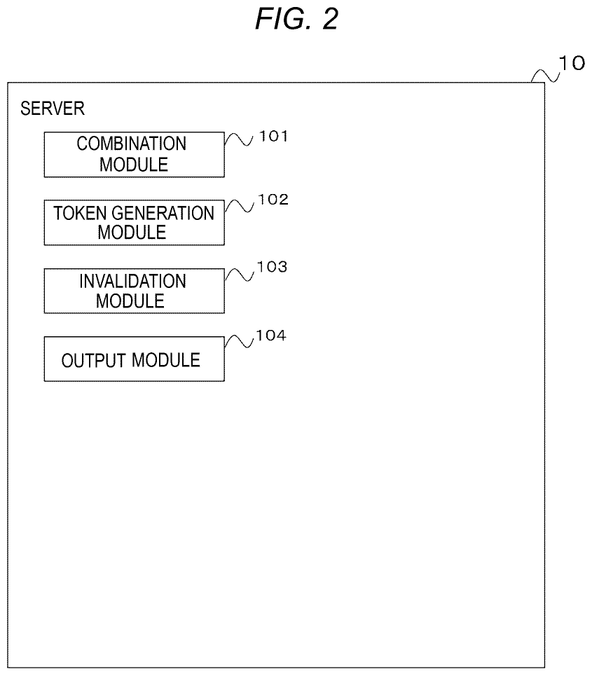

FIG. 2 is a block diagram illustrating a configuration of a server according to at least one embodiment of the present disclosure. The server 10 includes a combination module 101, a token generation module 102, an invalidation module 103, and an output module 104. The processor included in the server 10 executes the token management program stored in the storage device with reference to the program to functionally implement the combination module 101, the token generation module 102, the invalidation module 103, and the output module 104.

The combination module 101 has a function of combining a first object corresponding to a first token and a second object corresponding to a second token through superimposition.

The token generation module 102 has a function of generating a third token according to the combination.

The invalidation module 103 has a function of invalidating the tokens corresponding to the objects used for combination.

The output module 104 has a function of executing AR output of a third object to the output device. Here, the third object is an object corresponding to a third token. The third object is based on an object in which the first and second objects are superimposed. The AR output means an output in an AR space. For example, acquisition of the real world as a background image and display of the background image along with an object correspond to an AR output. Display of an object on a transparent or translucent window such as a front window of a vehicle corresponds to an AR output. Here, since the real word is shown over a window, an object is displayed using the real world as a background. The output includes display.

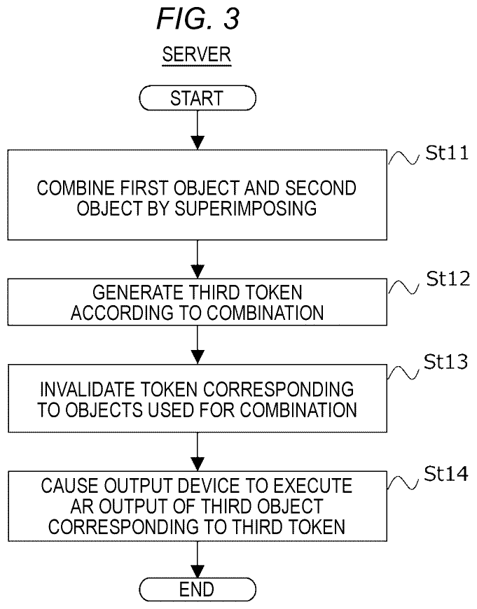

Next, a program execution process according to an embodiment of the present disclosure will be described. FIG. 3 is a flowchart illustrating a processing example of the token management program according to at least one embodiment of the present disclosure.

The combination module 101 combines the first object corresponding to the first token and the second object corresponding to the second token (St11). The combination is performed by superimposing the first and second objects.

The token generation module 102 generates the third token according to the combination (St12).

The invalidation module 103 invalidates the token corresponding to the objects used for the combination (St13).

The output module 104 executes AR output of the third object corresponding to the third token to the output device (St14). The third object is based on an object in which the first and second objects are superimposed.

A token typically means a non-fungible token (NFT). The token may be another type of token such as a fungible token (FT) or a re-fungible token (RFT), as long as there is no contradiction.

An object corresponding to a token means an object associated with the token. A type of the object does not matter as long as the object is an object that can be associated with a token. Example of the object include content such as image data, video data, and sound data. When a type of token is an NFT, an object is stored in a storage region of a server, an IPFS, or the like. An NFT on a blockchain can include link information to the object or the like.

The superimposition of the first and second objects means superimposition in which the first and second objects are superimposed to form a plurality of layers.

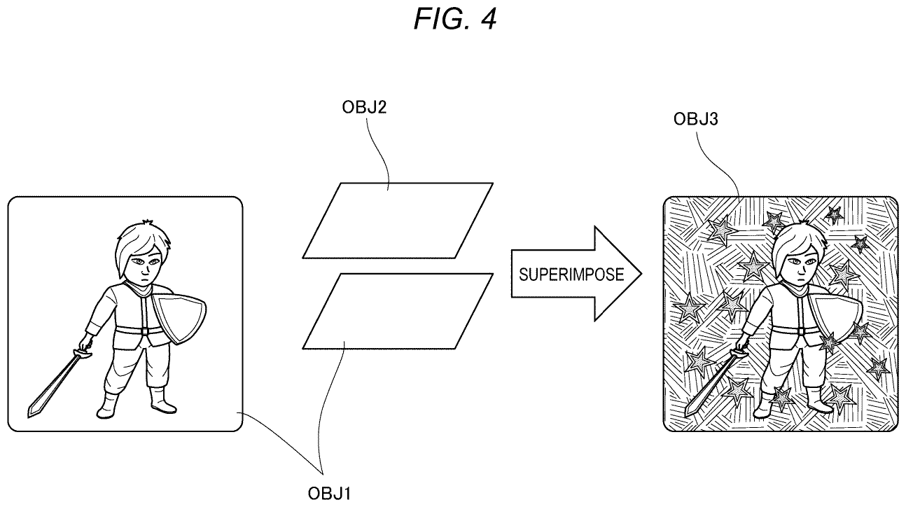

FIG. 4 is a conceptual diagram illustrating an example of superimposition of two objects according to at least one embodiment of the present disclosure.

A first object OBJ1 corresponding to a first token forms a first layer. A second object OBJ2 corresponding to a second token forms a second layer. A third object OBJ3 with a two-layered structure is generated by superimposing the first and second layers.

In FIG. 4, the first object OBJ1 may be, for example, a still image or a video. The second object OBJ2 may be a still image or a video. The combination module 101 combines the first object OBJ1 and the second object OBJ2 by superimposing two pieces of content in a layered form. Through the combination, the third object OBJ3 is formed.

When objects are still images or videos, the combination module 101 may superimpose a plurality of objects in a predetermined direction. The predetermined direction in the superimposition is the upper and lower directions in an example of FIG. 4. The predetermined direction may be any direction (for example, the vertical direction or the horizontal direction) in a virtual space or may be any direction on the real space when a service using augmented reality is executed. On the other hand, when voice data or the like is combined, the predetermined direction may not need to be conceptualized. Here, a sound may be combined with a still image, a video, or the like by a process of the combination module 101.

In FIG. 4, the third object OBJ3 is an object in which the first object OBJ1 and the second object OBJ2 are superimposed. The server 10 can merely execute the superimposition but also various types of image processing or the like on a new object formed through the superimposition. Therefore, the third object OBJ3 may be an object based on the object in which the first object OBJ1 and the second object OBJ2 are superimposed.

In step St12, the token generation module 102 generates the third token according to the combination. The generation of the third token mentioned here may mean a process of converting an NFT into mint and associating the NFT with the third object.

### Superimposition of Three or More Objects

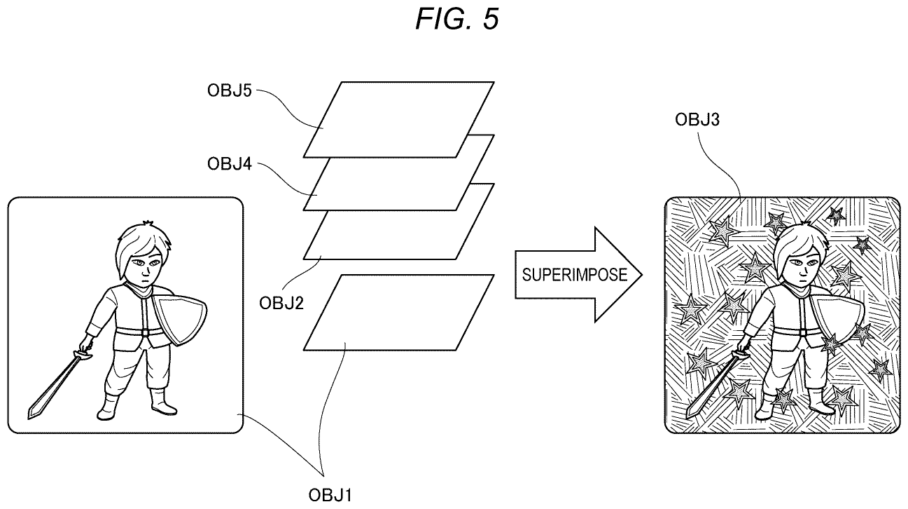

FIG. 5 is a conceptual diagram illustrating an example of superimposition of three or more objects according to at least one embodiment of the present disclosure.

The combination module 101 combines the first object OBJ1 corresponding to the first token, the second object OBJ2 corresponding to the second token, a fourth object OBJ4 corresponding to a fourth token, and a fifth object OBJ5 corresponding to a fifth token through superimposition. For example, the first object OBJ1 is a still image or a video having a sticker shape in which a character is drawn. The second object OBJ2, the fourth object OBJ4, and the fifth object OBJ5 are each a video, a still image with a png format, and the like. Through the combination, the third object OBJ3 in which the four objects OBJ1, OBJ2, OBJ4, and OBJ5 are superimposed is generated. Here, the third object OBJ3 is a moving character sticker.

As described above, the combination module 101 may combine objects corresponding to a plurality of tokens through superimposition.

### Handling of Tokens Corresponding to Objects Used for Combination

The tokens corresponding to the objects used for the combination may persist as they are without executing a process in particular. Here, the server 10 executing the token management program can express a behavior of producing a new separate object based on a plurality of objects.

On the other hand, the tokens corresponding to the objects used for the combination may be invalidated. Here, the server 10 executing the token management program can express a behavior of producing a combined object in which a plurality of objects are combined. In the flowchart illustrated in FIG. 3, in step St13, the invalidation module 103 invalidates the tokens corresponding to the objects used for the combination. Here, for example, referring to FIG. 4, the invalidation module 103 invalidates the first token corresponding to the first object OBJ1 and the second token corresponding to the second object OBJ2. For example, referring to FIG. 5, the invalidation module 103 invalidates the first token corresponding to the first object OBJ1, the second token corresponding to the second object OBJ2, the fourth token corresponding to the fourth OBJ4, and the fifth token corresponding to the fifth object OBJ5.

The invalidation of the tokens means that, for example, the tokens are burned or access to the tokens from a user is disabled.

The invalidation module 103 may further invalidate the objects used for the combination. The invalidation of the objects means that data of the objects is deleted, an invalidation flag managed by being associated with the objects is turned on, or access to the objects from a user is disabled.

### [AR Output of Object]

In step St14, the output module 104 causes the output device to execute the AR output of the third object corresponding to the third token. As exemplified in FIGS. 4 and 5, the third object OBJ3 is formed such that a plurality of objects are superimposed to form a plurality of layers. That is, the third object OBJ3 has the plurality of layers.

Here, for example, when a 2-dimensional animation generation program such as Spine is used, objects having a plurality of layers can be output (displayed) inside an AR space. When video data in which expressions of a plurality of layers are synthesized based on the objects having the plurality of layers is generated, the objects having the plurality of layers can be output (displayed) inside the AR space.

### Modified Examples

A computer may be caused to further implement an effect assignment unit of assigning different effects to combined objects in an order of superimposition of the objects corresponding to tokens.

As another effect example, attribute values of the combined objects may be set to be different, for example. For example, when objects are superimposed in the order of A, B, and C, the effect assignment unit sets attack power which is attribute values of the combined objects to 100. When the objects are superimposed in the order of B, A, and C, the effect assignment unit sets attack power which is attribute values of the combined objects to 120. The attack power is an example of the attribute value. The effect assignment unit may set other attribute values to be different according to the order of superimposition.

According to a combination of objects which are superimposition targets, the effect assignment unit may assign different effects to objects. For example, when the objects A, B, and C are superimposed, the effect assignment unit sets defense power which is attribute values of the combined objects to 80. When the objects A, B, and D are superimposed, the effect assignment unit sets defense power which is attribute values of the combined objects to 160. The defense power is an example of the attribute value. According to a combination of objects which are superimposition targets, the effect assignment unit may set other attribute values to be different.

As described above, the embodiments of the present application address one or more deficiencies. The advantageous effect in each embodiment is a non-limiting effect or an example of the effect.

In each of the above-described embodiments, the user terminal 20 and the server 10 executes the various processes described above according to any of various control programs (for example, the token management program) stored in their own storage devices. Other computers that are not limited to the user terminal 20 and the server 10 may execute the above-described various processes according to various control programs (for example, the token management program) stored in their own storage devices.

The configuration of the token management system 100 is not limited to the configurations described as examples of the above-described embodiments. For example, the server may execute some or all of the processes described as the processes executed by the user terminal, or the user terminal may execute some or all of the processes described as the processes executed by the server. The user terminal may be configured to include a part or all of the storage unit (storage device) included in the server. That is, in the token management system 100, one of the user terminal and the server may have some or all of the functions provided by the other.

Programs may be configured to cause a single device not including a communication network to implement some or all of the function described as examples of the above-described embodiments.

### [Note]

The foregoing embodiments have been described so that those who have ordinary knowledge in the field to which the inventions belong can implement the inventions.

[1] A token management program causing a computer to implement:
a combination function of combining a first object corresponding to a first token and a second object corresponding to a second token through superimposition; and
a token generation function of generating a third token according to the combination.

According to the token management program, it is possible to increase an interest of a user.

[2] The token management program according to [1], in which an invalidation function of invalidating the tokens corresponding to the objects used for the combination is further implemented.

According to the token management program, it is possible to prevent a disordered increase in the number of tokens.

[3] The token management program according to [2], in which, in the invalidation function, a function of further invalidating the objects used for the combination is implemented.

According to the token management program, it is possible to prevent a disordered increase in the number of objects corresponding to the tokens. It is possible to express the combination of the objects corresponding to the tokens.

[4] The token management program according to any one of [1] to [3], in which
a third object corresponding to the third token is based on an object in which the first and second objects are superimposed, and
the computer is caused to further implement an output function of causing an output device to execute AR output of the third object.

According to the token management program, it is possible to output the third object having a plurality of layers and obtained after the combination inside an AR space.

[5] A token management system that includes a communication network, a server, and a user terminal, the system comprising:
a combination means configured to combine a first object corresponding to a first token and a second object corresponding to a second token through superimposition; and
a token generation means configured to generate a third token according to the combination.

According to the token management system, it is possible to increase an interest of a user.

[6] A token management method by a computer, the method comprising:
a combination process of combining a first object corresponding to a first token and a second object corresponding to a second token through superimposition; and
a token generation process of generating a third token according to the combination.

According to the token management method, it is possible to increase an interest of a user.

An embodiment of the present disclosure is useful as a token management program, a token management system, and a token management method capable of increasing an interest of a user.

What is claimed is:

1. A non-transitory computer-readable medium that stores a token management program including instructions, when executed by one or more processors, causing a computer to perform operations comprising:
combining a first object corresponding to a first token and a second object corresponding to a second token through superimposition; and
generating a third token according to the combination.

2. The non-transitory computer-readable medium according to claim 1, wherein the operations further comprise invalidating the tokens corresponding to the objects used for the combination.

3. The non-transitory computer-readable medium according to claim 2, wherein the operations further comprise invalidating the objects used for the combination.

4. The non-transitory computer-readable medium according to claim 1, wherein a third object corresponding to the third token is based on superimposition of the first object and the second object, and
wherein the operations further comprise causing an output device to output the third object in an augmented reality space.

5. A token management system comprising:
a communication network;
a server;
a user terminal; and
one or more processors configured to:
combine a first object corresponding to a first token and a second object corresponding to a second token through superimposition; and
generate a third token according to the combination.

6. A token management method comprising:
combining a first object corresponding to a first token and a second object corresponding to a second token through superimposition by a computer; and
generating a third token according to the combined first and second objects.
